(19) United States
(12) Patent Application Publication
(10) Pub. No.: US 2010/0052197 A1
(43) Pub. Date: Mar. 4, 2010

(54) Method for Manufacturing Ceramic Honeycombs

(76) Inventors: Thomas James Deneka, Painted Post, NY (US); Andrew Charles Gorges, Addison, NY (US); Daniel Edward McCauley, Watkins Glen, NY (US); Anthony Nicholas Rodbourn, Bath, NY (US); Patrick David Tepesch, Corning, NY (US)

Correspondence Address: CORNING INCORPORATED, SP-TI-3-1, CORNING, NY, 14831, US

(21) Appl. No.: 12/411,587

(22) Filed: Mar. 26, 2009

Related U.S. Application Data
(60) Provisional application No. 61/092,260, filed on Aug. 27, 2008.

(51) Int. Cl. B29C 47/92

(52) U.S. Cl. 264/40.4

(57) ABSTRACT

Methods for making extruded ceramic products meeting set dimensional specifications comprise subjecting a small firing sample taken from a first unfired product preform to a rapid firing treatment to determine a value for firing shrinkage or growth, and then adjusting the dimensions of succeeding unfired preforms based on that value, e.g., by adjusting wet extruded product dimensions, so that the succeeding preforms will meet the set dimensional specifications.

### CROSS-REFERENCE To RELATED APPLICATIONS

This application claims the benefit of priority to U.S. provisional application No. 61/092,260, filed on Aug. 27, 2008.

### BACKGROUND

1. Field of Invention

The present invention is in the field of ceramic honeycomb manufacture, and more particularly relates to methods for manufacturing ceramic honeycomb products that provide improved product selection rates and thus reduced manufacturing costs.

2. Technical Background

Ceramic honeycombs useful as catalyst supports and filter substrates for the removal of pollutants from combustion engine exhaust gases are well known. Such honeycombs comprise a plurality of parallel channels or cells bounded by thin intersecting ceramic walls or webs, all channels lying parallel to a common channel axis. Honeycombs of rounded prismatic or cylindrical shape, having cross-sections of circular, oval, elliptical, or “racetrack” shape transverse to the common channel axis, are common. The ceramic walls of the channels provide surfaces for exhaust gas filtration and/or for the support of catalysts to neutralize the pollutants. For filtration applications, the channel walls are highly porous and the channels are selectively plugged to provide wall-flow filtration flow paths through the honeycombs, i.e. exhaust flow paths that force the exhaust gases to traverse the channel walls.

Current processes for the large-scale manufacture of porous ceramic honeycomb substrates useful in the construction of wall-flow particulate filters for the removal of particulates and other pollutants from combustion engine exhaust gases are complex and expensive. Plasticized batches of ceramic powders are continuously blended in large extruders, extruded through dies to form wet green honeycomb shapes comprising a plurality of parallel channels aligned with the extrusion direction, dried to remove liquid vehicle constituents, and finally fired to high temperatures in large kilns to convert the ceramic powders to reaction-sintered ceramics. The resulting strong, porous, refractory ceramic honeycomb substrates may be selectively plugged either before or after firing to provide wall-flow filter structures that efficiently remove particulates from engine exhausts. Such structures can be coated with catalysts to remove other exhaust pollutants if desired, and are sufficiently durable and refractory to provide long-term service in the harsh environment of heavy duty combustion engine exhaust systems.

The high costs of honeycomb manufacture require that product selection rates for the honeycombs be as high as possible. Customer requirements typically include strict tolerances for the dimensions of the honeycombs. Fired honeycomb products that do not have sizes or contours meeting these dimensional tolerances are not saleable and must be scrapped or recycled at considerable additional expense.

The economic production of extrude-to-shape honeycombs meeting strict contour tolerances for exhaust filters and other product applications requires an ability to control the dimensions of the fired honeycombs, and thus the dimensions of the wet extruded honeycomb shapes and dried honeycomb preforms. Control is complicated by the fact that firing shrinkage (or growth) is variable and subject to change as the result of raw material variability, batch processing inconsistencies, and other factors.

A typical filter contour specification for a filter substrate might require, for example, that the substrate cross-sectional shape match a target cross-sectional shape to within ±0.5%, i.e., that all cross-sectional dimensions of the fired part transverse to the common channel axis be within 0.5% of the corresponding target cross-sections. In the case of a circular cylindrical substrate, for example, the fired shape must have a cylinder diameter within ±0.5% of the specified filter diameter. More generally, the maximum honeycomb cross-sectional dimension perpendicular to the common channel axis must meet the same ±0.5% specification. Meeting such contour specifications thus requires that the firing-induced shrinkage or growth of the dried honeycomb substrates consistently fall within ±0.5% of the expected shrinkage/growth value.

Achieving effective firing shrinkage or growth compensation through control of extruded shape is further complicated by the fact that the firing cycles required to achieve high fired honeycomb yields are extremely long. Cycles of many days duration are required to fire the larger honeycomb types because gradual heating and cooling rates must be used to avoid firing cracks resulting from uneven reaction and phase changes, sintering shrinkage, and thermal stresses within the honeycombs. Long firing cycles mean that the time required to receive firing shrinkage feedback for ware in process is prohibitively long. Several days of production can be at significant risk of being out of dimensional tolerance, and significant fractions thereof can be lost in the event that unanticipated firing shrinkage or growth causes the final dimensions of some of that production to be out of customer contour specifications.

### SUMMARY

The present invention provides a rapid method for collecting firing shrinkage/growth information from dried honeycomb shapes. The method thus permits timely compensating adjustments to be made to the dimensions of wet extruded honeycomb shapes early in a production run, in order that the dried ware thereafter produced will meet the final required dimensional tolerances when fired. As an example of the benefit of the method, the invention reduces the time required to determine firing dimensional changes from a standard firing cycle for the dried honeycomb shape, e.g., 10-14 days for some honeycomb compositions, to one-half of the standard firing cycle or less, e.g., not exceeding 120 hours, or not exceeding 24 hours in some cases. The result is a considerable improvement in overall product selection rates and a corresponding reduction in filter production costs.

While the invention has wide application to the production of ceramic honeycomb substrates of essentially any of the known honeycomb compositions, e.g., cordierite, aluminum titanate, silicon carbide, silicon nitride or the like, it offers principal economic advantages for the production of high-performance cordierite or aluminum titanate filters. Raw materials costs for the latter filters are relatively high, the firing cycles needed to produce defect-free honeycombs are particularly long, and consistently meeting customer contour specifications for the finished filters requires particularly close attention to firing shrinkage variations.

In broad summary, the invention solves the problem of prolonged delays in obtaining firing shrinkage data feedback by measuring the dimensional changes exhibited by small samples of dried extruded honeycombs after processing through a highly accelerated, time-compressed firing cycle. The result is that data for projecting the firing-induced dimensional changes to be expected for any production run of extruded honeycombs can be generated in much shorter times than required to collect data from honeycombs fired through the conventional cycles, e.g., within firing times not exceeding 120 hours, or not exceeding 60 hours, or in some embodiments not exceeding 24 hours from the time the ware has completed the drying portion of the manufacturing process.

In a first aspect, therefore, embodiments according to the invention include a method of manufacturing a fired ceramic product such as a ceramic honeycomb to meet a set dimensional specification. That method comprises, first, subjecting a small section of a first unfired product preform for the product to a rapid firing treatment to determine a value for the firing shrinkage or growth for that preform.

Based on the value thus determined, one or more dimensions of a second and succeeding unfired product preforms are adjusted as necessary to compensate for the observed firing shrinkage, and the preforms with adjusted dimensions are fired to manufacture the ceramic products. Adjustment of the dimensions of the second and succeeding preforms is in an amount and direction effective to insure that the ensuing firing shrinkage or growth of the latter preforms, as projected from the firing shrinkage of the section of the first preform, will bring the fired ceramic products within the set dimensional specification.

Superior results are realized where the time between the production of the first dried ware for firing and the collection of firing shrinkage/growth data for that production is as short as possible. Accordingly, the rapid firing cycle used to generate that data is advantageously kept to the minimum time consistent with the need to secure results that are fairly predictive of the shrinkage or growth to be encountered during a standard firing of the same ware.

In another aspect, therefore, embodiments according to the invention include a method for manufacturing a fired ceramic product such as a ceramic honeycomb to provide a product contour within a specified dimensional tolerance, the method comprising the initial steps of: (a) forming a wet green ceramic extrudate of a target extruded dimension; (b) drying the extrudate to produce a first dried green product preform; (c) cutting at least one firing sample from the first dried green preform; (d) subjecting the firing sample to a rapid firing treatment to produce a fired sample; (e) determining a dimensional change resulting from the rapid firing treatment of the sample; (f) adjusting the target extruded dimension in response to the sample dimensional change to produce a second dried green product preform; and (g) firing the second dried green product preform to produce a fired ceramic product having a contour within the specified dimensional tolerance.

In some embodiments, the extrudate is formed from a plasticized blended mixture including ceramic precursors convertible to aluminum titanate or cordierite upon firing. Importantly, the firing sample or samples cut from the first dried green preform in accordance with step (c) above will be of a size sufficiently reduced from the size of the original dried green preform to prevent thermal or mechanical cracking thereof during the ensuing rapid firing. Many of the thermal and mechanical forces that arise in the course of reaction-sintering dried extruded honeycombs are proportional to the size of the structure being fired. Hence heating and cooling rates and temperatures that would cause the total destruction of large honeycomb structures can easily be tolerated by smaller samples.

The fact that the firing shrinkage or growth values resulting from the rapid firing of small samples may not precisely match the values exhibited during the prolonged firing of large honeycomb structures does not impact the utility of the inventive methods. That is because the differences in values are consistent and determinable, and thus easily factored into the adjustment of target extruded dimensions that may be carried out in accordance with the above procedures.

### BRIEF DESCRIPTION OF THE DRAWINGS

The invention is further described below with reference to the appended drawings, wherein:

FIG. 1 is schematic perspective view of a slice section of a dried extruded honeycomb shape;

FIG. 2 is schematic perspective view of a small honeycomb sample of a size and shape suitable for determining rapid firing shrinkage or growth; and

FIG. 3 is a graph correlating fast firing shrinkage/growth data with conventionally determined shrinkage/growth data.

### DETAILED DESCRIPTION

The methods herein described are generally applicable to a wide range of honeycomb compositions exhibiting variations in shrinkage or growth during firing, but may be applied with particular advantage to the production of ceramic products of current commercial interest including ceramic honeycomb bodies incorporating primary crystalline phases of aluminum titanate or cordierite. In general, these are first formed as wet green ceramic extrudates from plasticized blended mixtures comprising a liquid vehicle and a ceramic powder, which mixtures include ceramic precursors convertible to aluminum titanate or cordierite upon firing, and the extrudates are then dried to remove liquid vehicle components.

The procedure for generating rapid feedback of information relating to firing shrinkage/growth in accordance with the invention does not require the extrusion of special sample configurations. Dried green honeycomb preforms for sampling are simply taken from normal production at the conclusion of the drying cycle, in some embodiments being randomly selected from production parts at regular and/or frequent intervals, and slices are cut therefrom to provide sections for further cutting into small firing samples.

The cutting of sliced sections or so-called “cookies” from dried green preforms is carried out in such a way that opposing plane parallel faces provided reference surfaces that facilitate accurate slice thickness measurements. The sections are advantageously cut from interior sections of the dried honeycomb shapes to insure surface flatness and good surface quality. The slicing direction may be perpendicular to the common channel axis (i.e., the direction of extrusion of the honeycombs) or tangential thereto, depending in part upon whether or not the firing shrinkage or growth for the particular ceramic material of the honeycombs is expected to be isotropic. However, a convenient slice orientation is perpendicular to the common channel axis, providing plane parallel opposing faces lying in planes perpendicular to the channel axis or direction of channel orientation through the slice.

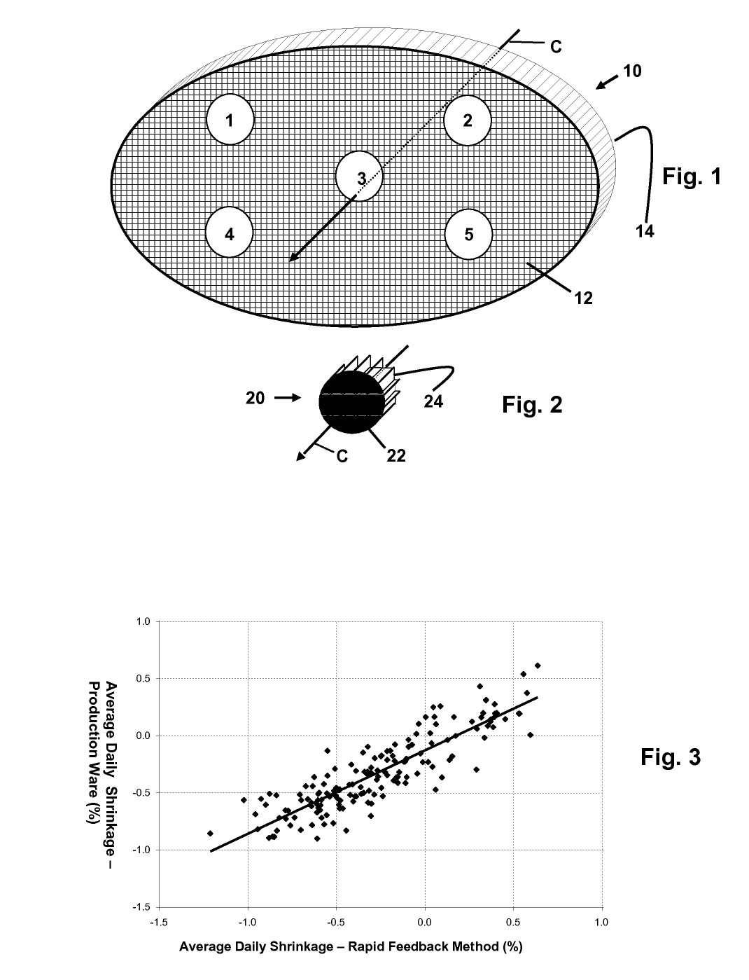

FIG. 1 of the drawings presents a schematic illustration of a typical slice 10 of a dried honeycomb shape, not in true proportion or to scale. Arrow C indicates the common channel axis or direction of channel orientation for the slice 10, with opposing plane parallel faces 12 and 14 of the slice being perpendicular thereto. In some embodiments slices such as illustrated in FIG. 1 are then further sectioned to produce small firing samples. The cross-sectional shapes of the small firing samples are not critical; cylindrical, square, rectangular, or other cross-sections are all useful. Exemplary suitable locations for extracting small cylindrical firing samples from a slice 10 are numbered 1-5 in the honeycomb section of FIG. 1. Of course, firing samples may be extracted from locations other than those shown in FIG. 1.

An example of a firing sample obtained as above-described is schematically illustrated as sample 20 in FIG. 2 of the drawings. A particular advantage of these slicing and sampling procedures is that firing samples such as sample 20 will retain opposing plane parallel surfaces 22 and 24, coincident with surfaces 12 and 14 in FIG. 1, that are disposed in planes perpendicular to the direction of channel orientation or common channel axis C in FIG. 2. A specific example of a sample size appropriate for rapid firing is a roughly cylindrical sample ½ inch in diameter and about ⅝ inch in height, height being the dimension between the opposing planar faces 22, 24, those surfaces lying perpendicular to the channel direction. The most dependable values for firing shrinkage or growth can be determined from the change in sample dimensions as measured between these two robust and consistent faces.

Rapid firing of samples such as described is suitably carried out in small kilns capable of rapid heating and cooling rates. Actual rates of heating and cooling are not critical, depending in part on the size, configuration, and composition of the samples, but will preferably be set as high as possible consistent with the need to retain sample integrity. In some embodiments, the rapid firing treatment involves at least one of: heating the sample at a rate in excess of 200° C./hr. during a heating phase of the treatment, and/or cooling the sample at a rate in excess of 300° C./hr. during a cooling phase of the treatment. In some embodiments the selected treatment will satisfy both of these requirements; however the most rapid yet effective heating and cooling rates for any particular sample composition and configuration can readily be determined by routine experiment.

An illustrative example of a suitable rapid firing schedule for firing dried preform samples for aluminum titanate-based ceramics having sample configurations as above-described comprises heating the samples at a ramp rate of 315° C./hr from ambient temperatures to 1425° C., holding the samples at 1425° C. for 16 hrs, and then cooling the samples to ambient at a cooling rate of 500° C./hr. Micrometer measurements taken before and after firing of the distance between opposing parallel faces of the sample, e.g., faces such as surfaces 22, 24 in FIG. 2, provide accurate and consistent measurements of the firing shrinkage or growth of this ceramic material.

The rapid firing schedule described above permits firing of samples in less than about 24 hours. However, even for samples that are unable to retain their integrity (i.e., not crack) in such a rapid firing schedule, longer rapid firing schedules, such as firing schedules about one-half of the standard firing cycle or less, may be beneficially employed. For materials utilizing days-long standard firing cycles, rapid firing schedules not exceeding, e.g., about 120 hours, about 90 hours, about 60 hours, etc. are beneficially employed.

There is a high degree of correlation between firing shrinkage/growth data as determined by a rapid firing method and that determined from ware processed through a standard commercial firing cycle. FIG. 3 of the drawings is a graph plotting shrinkage/growth data as collected by both methods over a production period of approximately 8 months. The values plotted in FIG. 3 are average daily firing shrinkage/growth values, with the rapid firing shrinkage for each comparison point being shown on the horizontal axis and the standard value being shown on the vertical axis. The degree of correlation shown confirms the value of rapid firing shrinkage/growth information as a strong predictor of the firing shrinkage/growth to be expected as the ware is processed through the commercial firing cycle.

The numerous advantages secured through the practice of the methods described herein are apparent from the foregoing description and examples. Rapid firing can reduce typical shrinkage data feedback from 10 days or more for standard production methods to less than 24 hours where rapid firing is used. Thus the quantity of ware at risk for being out of dimensional tolerance after firing is significantly reduced. These methods enable shrinkage variability to be managed on a day-to-day basis, thereby substantially increase average daily selection rates for ware within required dimensional tolerances.

As a consequence of the reduced delay in obtaining firing shrinkage feedback information, rapidly correcting for firing shrinkage variations by simply altering the wet dimensions of extruded honeycombs becomes practical. Such adjustments can easily provide dried unfired preforms having dimensions that will compensate for the firing shrinkage projected from the most current feedback data. In fact the shrinkage projections obtained from rapid firing shrinkage data are sufficiently accurate that the frequency of sampling production ware for adherence to dimensional specifications can be reduced.

Of course, the foregoing descriptions and specific embodiments according to the invention are intended to be illustrative rather than limiting, in that alternative embodiments and variations of the procedures particularly described above may readily be adapted to address the requirements of specific applications for the invention within the scope of the appended claims.

We claim:

1. A method of manufacturing a fired ceramic product within a set dimensional specification comprising the steps of:
subjecting a section of a first unfired product preform for the ceramic product to a rapid firing treatment to determine a value for a firing shrinkage or growth for the preform;
adjusting at least one preform dimension of a second unfired product preform based upon the value so determined; and
firing the second preform to manufacture the fired ceramic product; wherein
adjusting the at least one dimension of the second preform is effective to cause the firing shrinkage or growth to produce the fired ceramic product within the set dimensional specification.

2. A method in accordance with claim 1 wherein the ceramic product is an extruded ceramic honeycomb.

3. A method in accordance with claim 2 wherein the set dimensional specification includes a specification for a maximum honeycomb cross-sectional dimension perpendicular to a common channel axis of the ceramic honeycomb.

4. A method in accordance with claim 1 wherein the section of the first unfired preform for the product is a section of a dried ceramic honeycomb extrudate.

5. A method in accordance with claim 4 wherein the value for the firing shrinkage or growth is determined by a measurement of a dimension of the section aligned perpendicularly with or tangentially to a common channel axis of the section.

6. A method in accordance with claim 1 wherein the rapid firing treatment comprises at least one of:
heating the section at a rate in excess of 200° C./hr. during a heating phase of the treatment, and
cooling the section at a rate in excess of 300° C./hr. during a cooling phase of the treatment.

7. A method in accordance with claim 1 wherein the step of adjusting the at least one preform dimension of the second unfired preform includes a step of adjusting a dimension of a wet ceramic honeycomb extrudate used to form the second unfired preform.

8. A method in accordance with claim 1 wherein the ceramic product is an extruded cylindrical ceramic honeycomb of circular cross-section composed at least predominantly of aluminum titanate or cordierite ceramic.

9. A method in accordance with claim 8 wherein the set dimensional specification limits the variation of the diameter of the cylindrical honeycomb to ±0.5% of a target cylinder diameter.

10. A method for manufacturing a fired ceramic product having a contour within a specified dimensional tolerance comprising:
(a) forming a wet green ceramic extrudate having a target extruded dimension;
(b) drying the extrudate to produce a first dried green product preform;
(c) cutting at least one firing sample from the first dried green preform, the sample being of a size sufficiently reduced to prevent thermal or mechanical cracking of the sample during a rapid firing treatment;
(d) subjecting the firing sample to a rapid firing treatment to produce a fired sample;
(e) determining a sample dimensional change for the fired sample resulting from the rapid firing treatment;
(f) adjusting the target extruded dimension in response to the sample dimensional change to produce a second dried green product preform; and
(g) firing the second dried green product preform to produce a fired ceramic product having a contour within the specified dimensional tolerance.

11. A method in accordance with claim 10 wherein the wet green ceramic extrudate is a plasticized blended mixture comprising a liquid vehicle and a ceramic powder, said blended mixture including ceramic precursors convertible to aluminum titanate or cordierite upon firing.

12. A method in accordance with claim 11 wherein the fired ceramic product is a ceramic honeycomb body incorporating a primary crystalline phase of aluminum titanate or cordierite.

13. A method in accordance with claim 12 wherein the ceramic honeycomb body is a cylindrical body of circular, oval or elliptical cross-section incorporating a plurality of parallel channels aligned with a common channel axis of the body, and wherein the specified dimensional tolerance is ±0.5% of a maximum cylinder diameter perpendicular to the common channel axis.

14. A method in accordance with claim 13 wherein the firing sample is a section of a slice of the first dried green product preform, said slice having plane parallel opposing faces lying in planes perpendicular to the direction of the common channel axis.

15. A method in accordance with claim 14 wherein the sample dimensional change resulting from the rapid firing treatment is determined by a measurement of a change in spacing between the plane parallel opposing faces.

16. A method in accordance with claim 15 wherein the rapid firing treatment comprises heating the firing sample to a temperature and for a firing time at least sufficient to convert the ceramic precursors to aluminum titanate or cordierite, and wherein the firing time does not exceed about 120 hours.

17. A method in accordance with claim 16 wherein the firing time does not exceed about 60 hours.

18. A method in accordance with claim 16 wherein the firing time does not exceed about 24 hours.
